(19) United States
(12) Patent Application Publication
(10) Pub. No.: US 2024/0182285 A1
(43) Pub. Date: Jun. 6, 2024

(54) PACKAGING UNIT

(71) Applicant: ALPLA Werke Alwin Lehner GmbH & Co. KG, Hard (AT)

(72) Inventor: David Martin, Ludwigsstadt (DE)

(21) Appl. No.: 18/528,657

(22) Filed: Dec. 4, 2023

(30) Foreign Application Priority Data
Dec. 2, 2022 (CH) CH001444/2022

(51) Int. Cl. B67B 3/20; B65D 55/08; B65D 77/20

(52) U.S. Cl. CPC B67B 3/2073; B65D 55/089; B65D 77/202; B67B 3/2006

(57) ABSTRACT

The invention relates to a packaging unit having a first container for receiving free-flowing or liquid materials with a container body and a pouring opening which defines a first receiving space, a sealing cap for sealing the pouring opening, and a second container for receiving tablets, pills or pill-like materials, which defines a second receiving space. The sealing cap is configured as a screw cap, wherein the sealing cap and the second container are connected to one another in a rotationally fixed manner, such that a torque that is applied to the second container is transmitted to the sealing cap.

### CROSS-REFERENCE TO RELATED APPLICATION

This application claims priority to Swiss Patent Application No. CH001444/2022 filed on Dec. 2, 2022, the entirety of which is incorporated by this reference.

### FIELD OF THE INVENTION

The invention relates to a packaging unit having a container and a sealing cap for sealing a pouring opening of the container.

Such packaging units are known in the field of packaging of medicines or also food supplements. Typically, such packaging units consist of a first container for receiving free-flowing or liquid filling materials, which is sealed with a sealing cap, and a second container for receiving pills, tablets or comparable pill-like filling materials. The combination of the two filling materials in one packaging unit is intended in particular for the case where the filling materials represent a specific dosage for a specific period of time, i.e., for example, when they are packaged as a daily dose per packaging unit.

Usually, the first container is designed as a bottle, which is filled with nutrients or medications in liquid form. The second container forms the receiving space for receiving nutrients or medications in pill or tablet form and is configured such that the sealing cap is entirely overlapped by the second container. The disadvantage of such packaging units available on the market is that the described embodiment requires a lot of plastic material for their production.

### Advantages of the Invention

The present invention advantageously provides a packaging unit for different filling materials, which can be used easily and conveniently by a user. The present invention also advantageously provides a packaging unit for different filling materials that can be produced more cost-effectively compared with known packaging units of this type.

### SUMMARY OF THE INVENTION

A packaging unit according to the present invention includes a first container and a sealing cap configured to seal a pouring opening of the first container and configured as a screw cap wherein the sealing cap and a second container are connected to one another in a rotationally fixed manner, such that a torque that is applied to the second container is transmitted to the sealing cap. This creates an enlarged grip region, formed by the sealing cap and second container, for opening the sealing cap, making it easier for the user to open and seal. Provided that the sealing cap and the second container may be easily separated from one another, a user also has the option of consuming tablets, pills, coated tablets, or the like from the mounted or removed second container as desired. The design according to the invention also enables a slim design, which enables savings by reducing the amount of material required to produce the parts of the packaging unit.

In a first embodiment of the packaging unit according to the invention, the sealing cap and the second container are produced as two separate parts, wherein the sealing cap and the second container each have at least one fastening element engaged with one another for connecting the two parts. This makes it possible for the first container to be filled and sealed on a conventional filling line and for the second container to be filled and sealed on a second, separate line. Such filling operations may be performed independently of one another. Only when needed, the first and the second container are merged and connected to one another and may be delivered to customers.

It may be provided in the packaging unit according to the invention that a non-detachable connection is formed between the second container and the sealing cap of the first container. Thereby, a non-detachable connection means that the connection cannot be detached by a user without the aid of a tool and/or that the connection cannot be detached non-destructively. This is important when different but related products are to be provided in one packaging unit.

In a further embodiment of the packaging unit according to the invention, the sealing cap is designed as a screw cap, wherein the sealing cap and the second container are connected to one another in a rotationally fixed manner, such that a torque that is applied to the second container is transmitted to the sealing cap. Thus, a user who wants to open the screw cap may grasp either the sealing cap or the second container in order to open the screw cap by turning it. For this purpose, the receiving space may be designed as a recess arranged concentrically to the shell part, wherein ribs are formed on the side walls of the recess, which are aligned correspondingly to ribs of the fastening element, wherein such ribs are arranged on the outer side of a ring integrally and concentrically formed on the bottom side of the second container. The ribs on the outer side of the ring and the ribs on the side wall of the recess are aligned correspondingly relative to one another and form a kind of interlocking with one another. For example, this can ensure that torque applied to the second container is transmitted to the sealing cap.

With the packaging unit according to the invention, the sealing cap, which is formed from a shell part and a lid part, may have a receiving region in the lid part, in which at least one fastening element of the second container engages. Such clearance may be designed as a recess arranged concentrically to the shell part, with which a ring integrally and concentrically formed on the bottom side of the second container is pressed. In this manner, an interference fit is realized between the receiving region and the fastening element, in order to form an interference fit between the second container and the sealing cap. In an advantageous manner, a circumferential groove may be formed at the base of the recess for this purpose, in which the free end of the ring engages.

In an alternative embodiment of the packaging unit according to the invention, the connection between the second container and the sealing cap may be affected by means of a snap connection. For this purpose, a first bead or notch may be formed on the free end of the ring, which cooperates with a corresponding snap element, wherein such snap element is formed in the circumferential groove. In particular, such snap connection may be realized in an advantageous manner by a first bead at the free end of the ring on the one hand and by a corresponding snap element configured as a notch on the other hand, or in the opposite case by a notch at the free end of the ring on the one hand and by a corresponding snap element designed as a second bead on the other hand.

In another embodiment of the invention, the first container may be configured as a bottle and the second container may configured as a cup. The cup may be sealed by means of a sealing film. In order for the contents of the cup to be perceptible to a consumer, the cup may be made of transparent plastic material.

In particular, the sealing cap should be provided with a first-opening guarantee. For this purpose, a so-called tamper-evident band may be provided, which is connected to the free end of the shell part of the sealing cap via predetermined breaking webs.

In order to comply with statutory provisions concerning packaging materials, it may be necessary to captively fasten the sealing cap to the first container. Thereby, such fastening must ensure that the sealing cap remains connected to the container even if it is removed from the pouring opening. This may be done by means of specially provided retaining bands. At least one such retaining band may be arranged between the free end of the shell part and the tamper-evident band, wherein the retaining band is connected on the one hand to the shell part of the sealing cap via predetermined breaking webs and on the other hand to the tamper-evident band via predetermined breaking webs. Thereby, the retaining band does not extend over the entire circumference of the tamper-evident band, but only over a partial region of the circumference. For this purpose, reference is made by way of example to the Swiss patent application, application number CH 00663/21.

In a further embodiment, in order to further optimize the plastic material requirement in the production of the invention, the container body of the first container and the second container, along with the sealing cap, may each have a cylindrically configured shell surface, wherein the second container and the sealing cap each have approximately the same outer diameter and the outer diameter of the container body is equal to or greater than the outer diameter of the second container or the sealing cap. For the purposes of this invention, approximately the same diameters means a difference in the length of the diameters of 0 to 1 mm for a volume of the container body of 10 to 50 ml.

In another embodiment of the invention, ribs may be formed on the outer side of the sealing cap and on the outer side of the second container.

### BRIEF DESCRIPTION OF THE DRAWINGS

Further advantages and features will be apparent from the following description of an exemplary embodiment of the invention with reference to the embodiments described below. In the figures, in a presentation not to scale:

FIG. 1 shows an axonometric view of a packaging unit according to the invention in an assembled state, consisting of a first and second container and a sealing cap;

FIG. 2 shows a section through the axonometric view of the packaging unit according to FIG. 1;

FIG. 3 shows an axonometric view of the second container of the packaging unit according to FIG. 1;

FIG. 4 shows an axonometric view of the sealing cap of the packaging unit according to FIG. 1;

FIG. 5 shows a further axonometric view of the sealing cap according to FIG. 4;

FIG. 6 shows an axonometric view of the first container of the packaging unit according to FIG. 1.

### DETAILED DESCRIPTION OF THE INVENTION

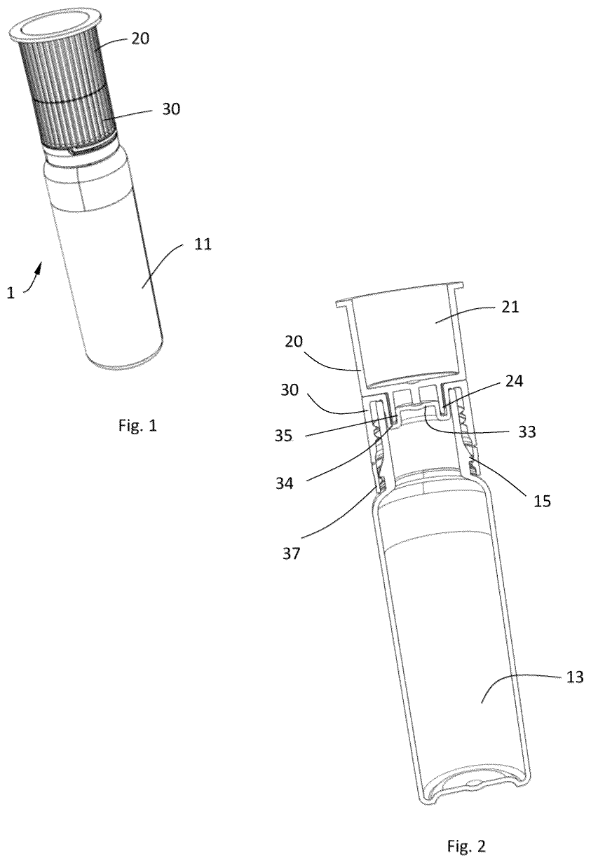

FIG. 1 shows a packaging unit, which is designated in its entirety by the reference sign 1. The packaging unit consists of a first container 10, a second container 20 and a sealing cap 30. The first container 10 is configured as a bottle and has a container body 11 and a pouring opening 12. The container body 11 forms a first receiving space 13. A screw thread 14 is located on the outer side of the pouring opening 12. A tamper-evident ring 15 is located below the screw thread. Such tamper-evident ring, in conjunction with the tamper-evident band 37, ensures the first-opening guarantee.

This is ensured by screwing or pressing the sealing cap 30 onto the pouring opening 12 for sealing the pouring opening 12. This causes securing elements, which are attached to the inner side of the tamper-evident ring, to wedge against the lower side of the tamper-evident ring 37. When the sealing cap 30 is screwed on, such wedging prevents the tamper-evident ring 15 from following the vertical movement of the sealing cap caused by the screwing process, and the predetermined breaking webs 38, via which the tamper-evident ring 15 is connected to the shell part 31 of the sealing cap 30, break open. It can thus be seen from the broken predetermined breaking webs that an opening has already taken place.

Space is provided in a region of the tamper-evident band 37 in order to accommodate a retaining band 41. Such retaining band 41 is also connected by means of predetermined breaking webs 38 on the one hand to the tamper-evident band 37 and on the other hand to the shell part 31. There is also a first connection 42 between the shell part 31 and the retaining band 41, and a second connection 43 between the tamper-evident band 37 and the retaining band 41. After the tamper-evident band 37 is wedged to the tamper-evident ring and the tamper-evident band is not removable, the sealing cap 30 is captively connected to the first container 10 by the retaining band 41 and even if the sealing cap 30 is unscrewed from the first container 10.

In FIG. 4, only the sealing cap 30 is shown. The sealing cap 30 consists of a lid part 32 adjoined by a shell part 31. FIG. 4 also clearly shows the retaining band 41 and the tamper-evident band 37. A thread, not shown, which may cooperate with the screw thread, is located on the inner side of the shell part 31. The lid part 32 has a receiving region, which is provided to receive fastening elements formed on the second container 20. Such receiving region is configured as a concentric recess 33 and has a circumferential groove 34 at the base of the recess. A second bead 35 is formed on the inner side wall of the groove 34. This second bead 35 may be formed circumferentially or with multiple interruptions.

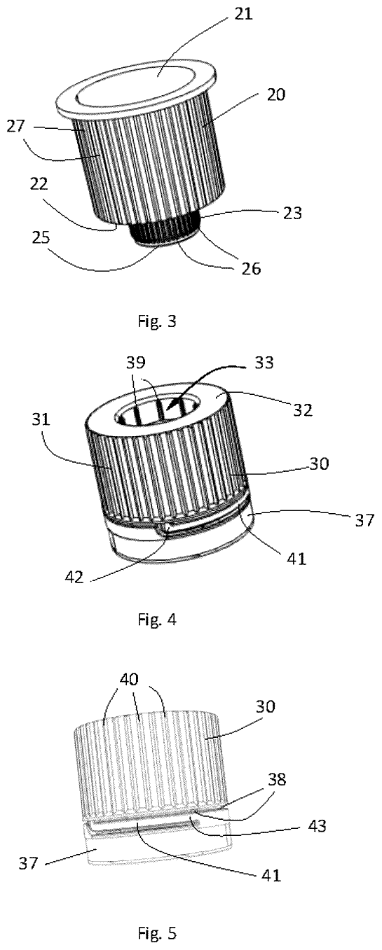

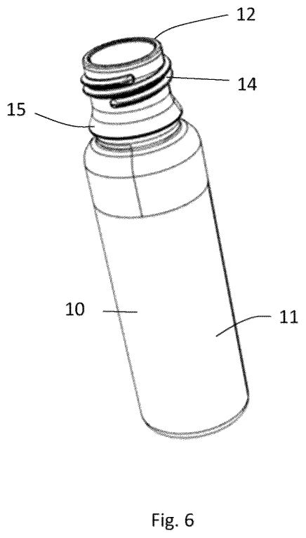

FIG. 3 shows the second container 20, which is configured as a cup. The cup has a second receiving space 21 and may be sealed with a sealing film, which is not shown. A fastening element is concentrically formed on its bottom side 22. In FIG. 2, such fastening element is shown engaging the recess 33. In the present exemplary embodiment, the fastening element is designed as a ring 23. A circumferential or also a circumferential but multiple interrupted first bead 24 is located on the inner side of the ring. Such first bead 24 and the second bead 35 form a very strong interference fit between the second container 20 and the sealing cap 30 in the region of the groove 34 and the free end 25 of the ring 23.

As an alternative to an interference fit, the connection between the second container 20 and the sealing cap 30 in the region of the recess 33 and the ring 23 may also be designed as a snap connection (not shown).

The ring 23 is provided with first ribs 26 on its outer side. Similarly, second ribs 39 are formed on the side walls of the recess 33. The first ribs 26 and the second ribs 39 form a type of interlocking if the ring 23 is engaged with the recess 33. In addition to other measures, such as an interference fit or a corresponding design of the snap connection, such interlocking ensures that a torque applied to the second container is transmitted to the sealing cap.

Vertically aligned first and second outer ribs 27 and 40, respectively, are located on the outer side of the second container 20 and the sealing cap 30. For design reasons in particular, the number of first and second ribs 27, 40 is the same.

The second container 20 may be made of transparent material, in particular polypropylene. Similarly, the sealing cap and the first container may be made of polypropylene. However, the material may be customized and also functionally optimized.

What is claimed is:

1. A packaging unit, comprising:
a first container configured for receiving free-flowing or liquid materials and having a container body and a pouring opening that defines a first receiving space,
a sealing cap for sealing the pouring opening, and
a second container configured for receiving tablets, pills or pill-like materials, and that defines a second receiving space,
wherein the sealing cap is configured as a screw cap, and wherein the sealing cap and the second container are connected to one another in a rotationally fixed manner, such that when a torque is applied to the second container the torque is transmitted to the sealing cap.

2. The packaging unit according to claim 1, wherein the sealing cap and the second container are produced as two separate parts, wherein the sealing cap and the second container each have at least one respective fastening element engaged with one another for connecting the sealing cap and the second container together.

3. The packaging unit according to claim 1, wherein the second container is non-detachably connected to the sealing cap.

4. The packaging unit according to claim 1, wherein the sealing cap is formed from a shell part and a lid part, and wherein the lid part has a receiving region in which at least one fastening element of the second container engages.

5. The packaging unit according to claim 4, wherein the receiving region is formed by a recess arranged concentrically to the shell part, and wherein a ring is integrally and concentrically formed on a bottom side of the second container and is pressed therewith, in order to form an interference fit between the second container and the sealing cap.

6. The packaging unit according to claim 5, wherein a circumferential groove is formed at a base of the recess, in which a free end of the ring engages.

7. The packaging unit according to claim 5, wherein the second receiving space is configured as a recess concentrically arranged to a shell part, wherein second ribs are formed on side walls of the recess and are aligned correspondingly to first ribs of the fastening element, wherein the first ribs are arranged on an outer side of the ring integrally and concentrically formed on the bottom side of the second container.

8. The packaging unit according to claim 4, wherein the receiving region is formed by a recess arranged concentrically to the shell part, and that a ring integrally and concentrically formed on a bottom side of the second container is snapped together therewith, in order to form a snap connection between the second container and the sealing cap.

9. The packaging unit according to claim 8, wherein a first bead or a notch is formed at a free end of the ring, which cooperates with a corresponding one of a plurality of snap elements formed in the circumferential groove.

10. The packaging unit according to claim 9, wherein a first of the plurality of snap elements where the first bead is formed on the free end of the ring, is configured as a notch and, wherein a second of the plurality of snap elements where a circumferential notch is formed on the free end of the ring, is configured as a second bead, wherein the first and second plurality of snap elements are circumferentially configured.

11. The packaging unit according to claim 1, wherein the first container is configured as a bottle.

12. The packaging unit according to claim 1, wherein the second container is configured as a cup.

13. The packaging unit according to claim 6, wherein the second container is made of transparent material and is sealed with a sealing film.

14. The packaging unit according to claim 6, wherein a free end of the shell part of the sealing cap is connected to a tamper-evident band via predetermined breaking webs.

15. The packaging unit according to claim 14, wherein between the free end of the shell part and the tamper-evident band, at least one retaining band is arranged in certain regions, which is connected to the shell part via a first plurality of predetermined breaking webs and to the tamper-evident band via a second plurality of predetermined breaking webs.

16. The packaging unit according to claim 1, wherein the container body of the first container, the second container, and the sealing cap each have a cylindrically configured outer surface, wherein at least the second container and the sealing cap each have an approximately equal outer diameter and the container body has an outer diameter that is equal to or greater than the approximately equal outer diameter of the sealing cap.

17. The packaging unit according to claim 1, further comprising first outer ribs formed on an outer side of the sealing cap and second outer ribs formed on an outer side of the second container.
